(19) United States
(12) Patent Application Publication
(10) Pub. No.: US 2016/0012571 A1
(43) Pub. Date: Jan. 14, 2016

(54) IMAGE PROCESSOR AND IMAGE PROCESSING SYSTEM INCLUDING THE SAME

(71) Applicant: SAMSUNG ELECTRONICS CO., LTD., Suwon-si (KR)

(72) Inventor: JAE HO YANG, Cheonan-si (KR)

(21) Appl. No.: 14/676,159

(22) Filed: Apr. 1, 2015

Related U.S. Application Data
(60) Provisional application No. 62/023,366, filed on Jul. 11, 2014.

(30) Foreign Application Priority Data
Oct. 29, 2014 (KR) 10-2014-0148083

(51) Int. Cl. G06T 5/00; G06T 5/40; G09G 5/10; G09G 3/36; G09G 3/34

(52) U.S. Cl. CPC G06T 5/007; G09G 3/3607; G09G 3/3406; G09G 5/10; G06T 5/40; G09G 2320/0271; G09G 2320/0626; G09G 2360/16; G09G 2320/0646; G09G 2330/021; G06T 2207/10016; G06T 2207/10024; G06T 2207/20208

(57) ABSTRACT

An image processor includes a gain controller and a data processing block. The gain controller is configured to adjust an initial gain value of a first tone mapping function corresponding to first image data using a dimming step value until the initial gain value is the same as a target gain value of a second tone mapping function corresponding to second image data. The data processing block is configured to generate a final tone mapping function using a reference function and a third tone mapping function generated based on the adjusted initial gain value. The first image data is data before a scene change occurs, and the second image data is data after the scene change occurs. The tone mapping function is a first-order function generated using the adjusted initial gain value. An order of the reference function is higher than an order of the tone mapping function.

### CROSS-REFERENCE TO RELATED APPLICATIONS

This application claims priority under 35 U.S.C. §119(e) to U.S. provisional patent application No. 62/023,366, filed on Jul. 11, 2014, and under 35 U.S.C. §119(a) to Korean Patent Application No. 10-2014-0148083, filed on Oct. 29, 2014, the disclosures of which are incorporated by reference herein in their entireties.

### TECHNICAL FIELD

Exemplary embodiments of the present inventive concept relate to an image processor, and more particularly, to an image processor for minimizing deterioration of picture quality and reducing power consumption during tone mapping control and backlight unit control, and an image processing system including the same.

### DISCUSSION OF THE RELATED ART

An image processor for controlling brightness of a display using a backlight unit and a gamma correction curve has been developed. Thus, power consumption of the display may be reduced and visibility thereof may be increased.

For instance, contents-based adaptive backlight control (CABC) controls a backlight and a gamma value of an image according to picture information of a liquid crystal display (LCD) to reduce power consumption. In the CABC, brightness information of an image is calculated using a histogram method or the like, a gain value corresponding to the brightness information is set using an internal gain setting algorithm, and image data is multiplied by the set gain value.

### SUMMARY

According to an exemplary embodiment of the present inventive concept, there is provided an image processor. The image processor includes a gain controller and a data processing block. The image processor is configured to adjust an initial gain value of a first tone mapping function corresponding to first image data using a dimming step value until the initial gain value is the same as a target gain value of a second tone mapping function corresponding to second image data. The data processing block is configured to generate a final tone mapping function using a reference function and a third tone mapping function generated based on the adjusted initial gain value. The first image data is data before a scene change occurs, and the second image data is data after the scene change occurs. The third tone mapping function is a first-order function generated using the adjusted initial gain value. An order of the reference function is higher than an order of the tone mapping function.

The image processor may further include an image classifier configured to classify the first image data as a first image category and classify the second image data as a second image category.

The gain controller may increase the initial gain value using the dimming step value until the initial gain value reaches the target gain value when the initial gain value is less than the target gain value. The gain controller may decrease the initial gain value using the dimming step value until the initial gain value reaches the target gain value when the initial gain value is greater than the target gain value.

When the target gain value is between a first value obtained by adding the dimming step value to the initial gain value and a second value obtained by subtracting the dimming step value from the initial gain value, the gain controller may set the initial gain value to the target gain value.

The final tone mapping function may be the same as the third tone mapping function in a range from an initial value of the second image data to a first value of the second image data, and the final tone mapping function may be the same as the reference function in a range from the first value to a last value of the second image data. The first value may correspond to an intersection of the third tone mapping function and the reference function.

The data processing block may include a bit extender, a tone mapping function control block, and a dithering block. The bit extender may be configured to convert the second image data having a first number of bits into extended image data having a second number of bits greater than the first number of bits. The tone mapping function control block may be configured to generate the final tone mapping function using the extended image data, the adjusted initial gain value, and the reference function, and to generate final image data using the extended image data and the final tone mapping function. The dithering block may be configured to convert the final image data into output image data having the first number of bits, and to output the output image data. The dimming step value may be programmable.

The reference function may be generated using a look-up table that stores values for minimizing deterioration of picture quality of the second image data.

The image classifier may include a histogram generator, a feature extractor, and an image category selector. The histogram generator may be configured to generate a first luminance histogram of the first image data and a second luminance histogram of the second image data. The feature extractor may be configured to extract first feature points of the first image data from the first luminance histogram, and to extract second feature points of the second image data from the second luminance histogram. The image category selector may be configured to classify the first image data as the first image category using the first feature points, and to classify the second image data as the second image category using the second feature points.

According to an exemplary embodiment of the present inventive concept, there is provided an image processing system. The image processing system includes a display and an image processor. The image processor is configured to output output image data to the display. The image processor includes a gain controller and a data processing block. The gain controller is configured to adjust an initial gain value of a first tone mapping function corresponding to first image data using a dimming step value until the initial gain value is the same as a target gain value of a second tone mapping function corresponding to second image data. The data processing block is configured to generate a final tone mapping function using a reference function and a third tone mapping function generated based on the adjusted initial gain value and to output the output image data generated using the final tone mapping function. The first image data is data before a scene change occurs, and the second image data is data after the scene change occurs. The third tone mapping function is a first-order function generated using the adjusted initial gain value. An order of the reference function is higher than an order of the third tone mapping function.

The gain controller may increase the initial gain value using the dimming step value until the initial gain value reaches the target gain value when the initial gain value is less than the target gain value. The gain controller may decrease the initial gain value using the dimming step value until the initial gain value reaches the target gain value when the initial gain value is greater than the target gain value.

The final tone mapping function may be the same as the third tone mapping function in a range from an initial value of the second image data to a first value of the second image data. The final tone mapping function may be the same as the reference function in a range from the first value to a last value of the second image data. The first value may correspond to an intersection of the third tone mapping function and the reference function.

The data processing block may include a bit extender, a tone mapping function control block, an a dithering block. The bit extender may be configured to convert the second image data having a first number of bits into extended image data having a second number of bits greater than the first number of bits. The tone mapping function control block may be configured to generate the final tone mapping function using the extended image data, the adjusted initial gain value, and the reference function, and to generate final image data using the extended image data and the final tone mapping function. The dithering block may be configured to convert the final image data into output image data having the first number of bits, and to output the output image data.

According to an exemplary embodiment of the present inventive concept, there is provided an image processor. The image processor includes a gain controller and a backlight controller. The gain controller is configured to adjust an initial gain value for a backlight control corresponding to first image data using a dimming step value until the initial gain value is the same as a target gain value for a backlight control corresponding to second image data. The backlight controller is configured to output a backlight control signal using the adjusted initial gain value. The first image data is data before a scene change occurs, and the second image data is data after the scene change occurs.

The image processor may further include an image classifier configured to classify the first image data as a first image category and to classify the second image data as a second image category.

The gain controller may increase the initial gain value using the dimming step value until the initial gain value reaches the target gain value when the initial gain value is less than the target gain value. The gain controller may decrease the initial gain value using the dimming step value until the initial gain value reaches the target gain value when the initial gain value is greater than the target gain value.

When the target gain value is between a first value obtained by adding the dimming step value to the initial gain value and a second value obtained by subtracting the dimming step value from the initial gain value, the gain controller may adjust the initial gain value to the target gain value. The dimming step value may be programmable.

According to an exemplary embodiment of the present inventive concept, there is provided an image processor. The image processor includes an image classifier, a gain controller, and a data processing block. The image classifier is configured to classify a category of image data, and to output the classified image category information to a gain controller. The gain controller is configured to adjust a first gain value of a first tone mapping function corresponding to first image data to be the same as a second gain value of a second tone mapping function corresponding to second image data using the second image data and the classified image category information. The data processing block is configured to generate a tone mapping function using a reference function and a third tone mapping function generated based on the adjusted first gain value.

### BRIEF DESCRIPTION OF THE DRAWINGS

The above and other features of the present inventive concept will become more apparent by describing in detail exemplary embodiments thereof with reference to the attached drawings in which:

FIG. 1 is a block diagram of an image processing system according to an exemplary embodiment of the present inventive concept;

FIG. 2 is a block diagram of an image classifier illustrated in FIG. 1 according to an exemplary embodiment of the present inventive concept;

FIG. 3 is a diagram of a luminance histogram of image data input to the image classifier illustrated in FIG. 2 according to an exemplary embodiment of the present inventive concept;

FIG. 4 is a diagram of types of image categories for explaining an operation of an image category selector illustrated in FIG. 2 according to an exemplary embodiment of the present inventive concept;

FIG. 5 is a block diagram of a gain controller illustrated in FIG. 1 according to an exemplary embodiment of the present inventive concept;

FIG. 6 is a graph for explaining an operation of a gain controller illustrated in FIG. 1 according to an exemplary embodiment of the present inventive concept;

FIG. 7 is a diagram for explaining the operation of the gain controller illustrated in FIG. 1 according to an exemplary embodiment of the present inventive concept;

FIG. 8 is a diagram for explaining an example of the operation of the gain controller illustrated in FIG. 1 according to an exemplary embodiment of the present inventive concept;

FIG. 9 is a diagram for explaining an example of the operation of the gain controller illustrated in FIG. 1 according to an exemplary embodiment of the present inventive concept;

FIG. 10 is a block diagram of a data processing block illustrated in FIG. 1 according to an exemplary embodiment of the present inventive concept;

FIG. 11 is a diagram for explaining an operation of the data processing block illustrated in FIG. 1 according to an exemplary embodiment of the present inventive concept;

FIG. 12 is a graph for explaining a method of generating a final tone mapping function using the data processing block illustrated in FIG. 1 according to an exemplary embodiment of the present inventive concept;

FIG. 13 is a graph for explaining a method of generating a final tone mapping function using the data processing block illustrated in FIG. 1 according to an exemplary embodiment of the present inventive concept;

FIG. 14 is a block diagram of an image processing system according to an exemplary embodiment of the present inventive concept;

FIG. 15 is a block diagram of an image processing system according to an exemplary embodiment of the present inventive concept; and

FIG. 16 is a block diagram of an image processing system according to an exemplary of the present inventive concept.

### DETAILED DESCRIPTION OF THE EMBODIMENTS

Hereinafter, the present inventive concept now will be described more fully with reference to the accompanying drawings, in which exemplary embodiments of the present inventive concept are shown. The present inventive concept may, however, be embodied in many different forms and should not be construed as limited to the exemplary embodiments set forth herein. In the drawings, the size and relative sizes of layers and regions may be exaggerated for clarity. Like numbers may refer to like elements throughout the application.

It will be understood that when an element is referred to as being “connected” or “coupled” to another element, it can be directly connected or coupled to the other element or intervening.

As used herein, the singular forms “a”, “an” and “the” are intended to include the plural forms as well, unless the context clearly indicates otherwise.

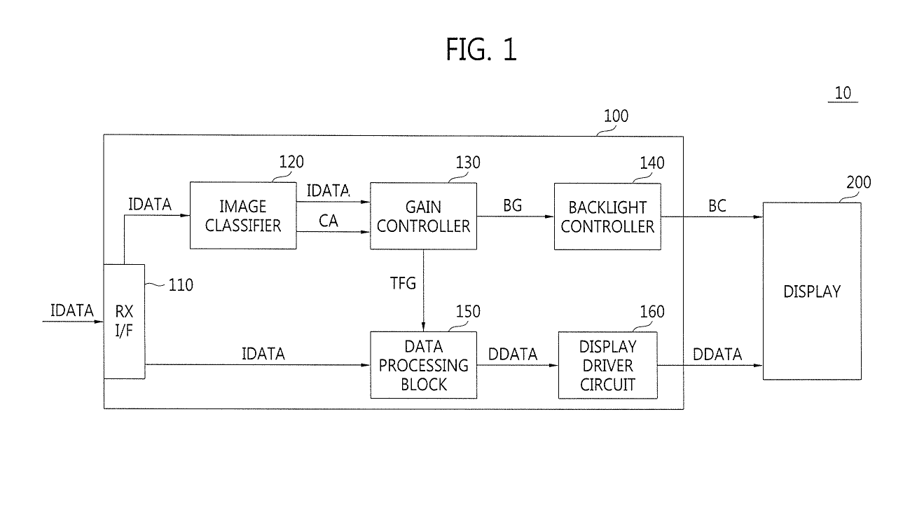

FIG. 1 is a block diagram of an image processing system 10 according to an exemplary embodiment of the present inventive concept. The image processing system 10 may be implemented as a television (TV) or a portable electronic device. The portable electronic device may be a laptop computer, a cellular phone, a smart phone, a tablet personal computer (PC), a personal digital assistant (PDA), an enterprise digital assistant (EDA), a digital still camera, a digital video camera, a portable multimedia player (PMP), a mobile internet device (MID), a wearable computer, an internet of things (IoT) device, an internet of everything (IoE) device or the like.

The image processing system 10 includes an image processor 100 and a display 200. The image processor 100 may be implemented as an integrated circuit (IC), a system on chip (SoC), an application processor (AP), a mobile AP, or a display driver IC that can drive the display 200.

The image processor 100 may include a receive interface (RX I/F) 110, an image classifier 120, a gain controller 130, a backlight controller 140, a data processing block 150, and a display driver circuit 160. In an exemplary embodiment of the present inventive concept, the image processor 100 may be included in the display 200 or a terminal including the display 200. The image processor 100 may adjust luminance of an input image according to a power mode of the display 200 and the luminance distribution characteristic of the input image.

The image processor 100 receives current image data IDATA through the RX I/F 110. The image classifier 120 may determine an image category for the current image data IDATA. The image category is a model that represents the luminance distribution characteristic of the current image data IDATA. The number and types of image categories may be predetermined. When a scene change occurs among image data, the image category may be changed. When there is no scene change among the image data, the image category may be maintained.

The image processor 100 may determine an image category of the current image data IDATA based on whether a scene change occurs in the current image data IDATA, and may increase the brightness of the current image data IDATA by applying an appropriate tone mapping function (TMF) to the image category. The TMF is a function that represents a pattern optimized to adjust luminance of an image belonging to an image category in a low-power mode. An output luminance value may be determined according to the TMF and an input luminance value. The TMF may be predetermined and stored in a register in advance.

The image classifier 120 may classify first image data (hereinafter, referred to as “previous image data”) as a first image category and second image data (hereinafter, referred to as “current image data”) as a second image category. The previous image data may be image data before a scene change occurs and the current image data may be image data after the scene change occurs. When there is no scene change, the first image category corresponding to the previous image data may be the same as the second image category corresponding to the current image data.

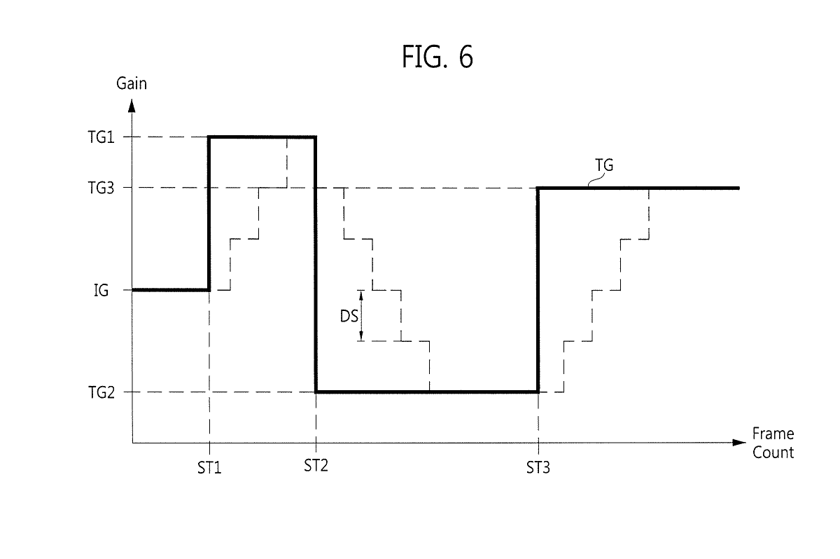

FIG. 6 is a graph for explaining an operation of a gain controller 130 illustrated in FIG. 1 according to an exemplary embodiment of the present inventive concept. Referring to FIGS. 1 and 6, the gain controller 130 may receive the current image data IDATA from the image classifier 120 and may linearly adjust a gain value, which corresponds to image category information CA determined by the image classifier 120, using a dimming step value DS.

The gain value may include a gain value of a TMF and/or a gain value for backlight control. The dimming step value DS may have been set in the gain controller 130 according to a type of the current image data IDATA. The dimming step value DS may be programmable.

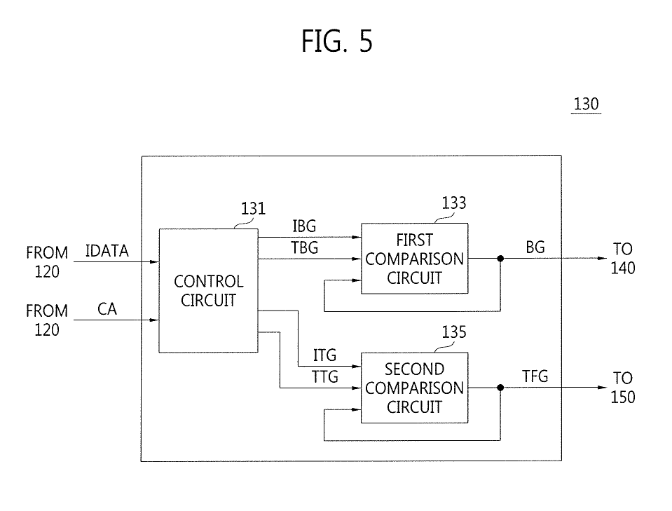

The gain controller 130 may linearly adjust an initial gain value IG of a TMF corresponding to the first image category using the dimming step value DS until the initial gain value IG is the same as a target gain value TG of a TMF corresponding to the second image category. In an exemplary embodiment of the present inventive concept, the gain controller 130 may linearly adjust the initial gain value IG for backlight control corresponding to the first image category using the dimming step value DS until the initial gain value IG is the same as the target gain value TG for backlight control corresponding to the second image category. The operation of the gain controller 130 will be described in detail with reference to FIGS. 5 through 9 later.

The backlight controller 140 outputs a backlight control signal BC to a backlight unit control circuit included in the display 200. The backlight unit control circuit may control a backlight unit using the backlight control signal BC. The backlight controller 140 may adjust the initial gain value IG for the backlight control until the initial gain value IG reaches the target gain value TG for the backlight control, and may generate the backlight control signal BC using the adjusted initial gain value.

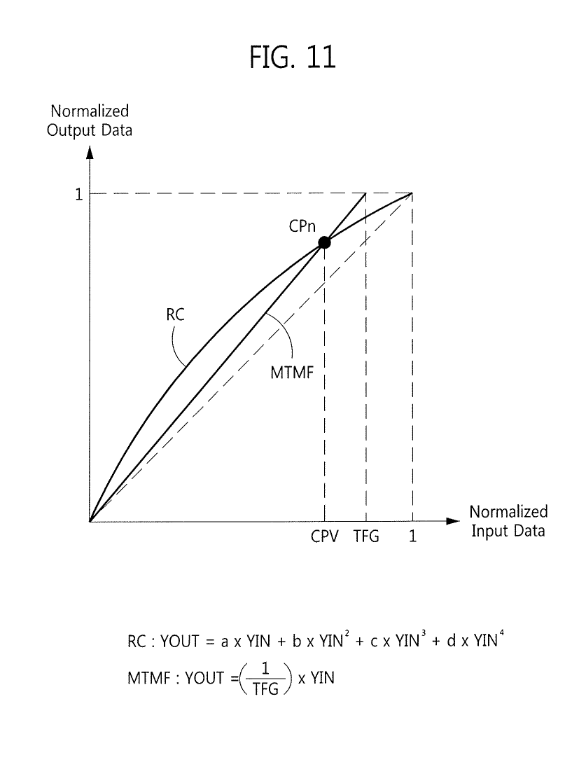

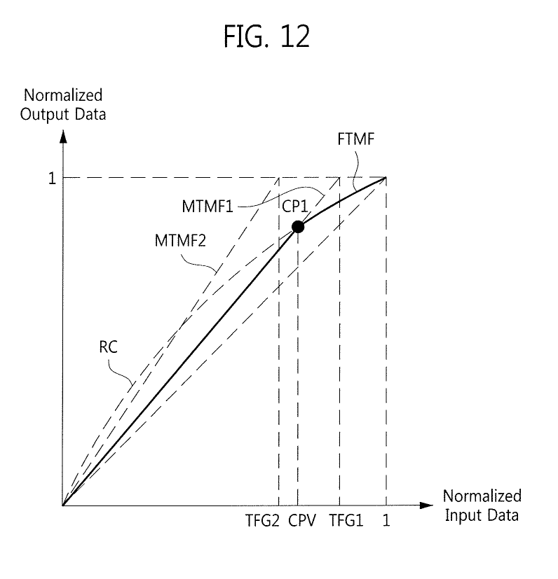

The data processing block 150 may generate a final TMF (e.g., FTMF illustrated in FIG. 12) using a TMF (e.g., MTMF in FIG. 11) and a reference function (e.g., RC in FIG. 11). The TMF (e.g., MTMF in FIG. 11) may be generated based on a TMF's initial gain value (e.g., TFG in FIG. 11) that is linearly adjusted by the gain controller 130. The TMF MTMF may be a first-order function generated using the adjusted initial gain value TFG. The reference function (e.g., RC in FIG. 11) is a function that can be applied in common to input images for effective image reproduction. The reference function RC may be set in advance in the data processing block 150. The order of the reference function RC may be greater than the order of the TMF MTMF. In an exemplary embodiment of the present inventive concept, the reference function RC may be generated using a lookup table that stores values for minimizing deterioration of the picture quality of the current image data IDATA.

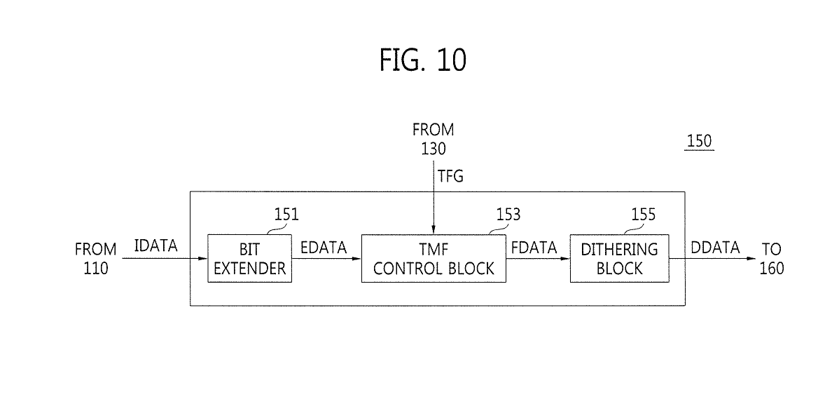

Referring to FIGS. 1, 11, and 12, the final TMF FTMF is the same as the TMF MTMF in a range from an initial value (e.g., “0”) of the current image data IDATA to a first value CPV of the current image data IDATA. The final TMF FTMF is the same as the reference function RC in a range from the first value CPV to a last value (e.g., “1”) of the current image data IDATA. Accordingly, the final TMF FTMF may be determined based on the two functions MTMF and RC. The first value CPV corresponding to a value an intersection CPn of the TMF MTMF and the reference function RC. The operation of the data processing block 150 will be described in detail with reference to FIGS. 10 through 13 later.

The display driver circuit 160 receives dithered output data DDATA from the data processing block 150 and outputs the dithered output data DDATA to the display 200. The display 200 displays the dithered output data DDATA using the backlight control signal BC received from the image processor 100. The display 200 may be implemented as a liquid crystal display (LCD) including a backlight unit.

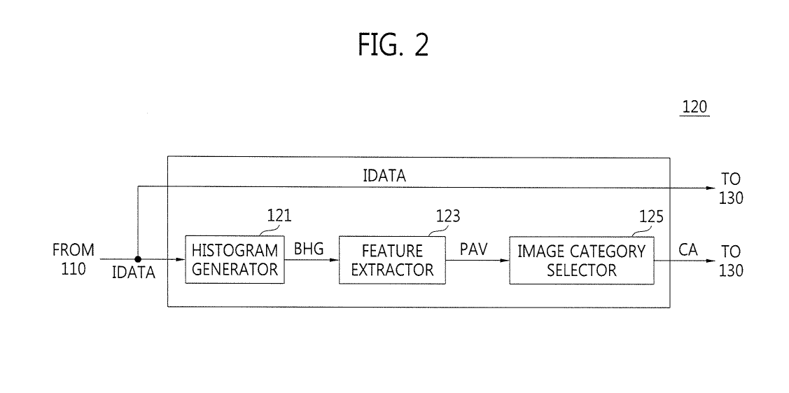

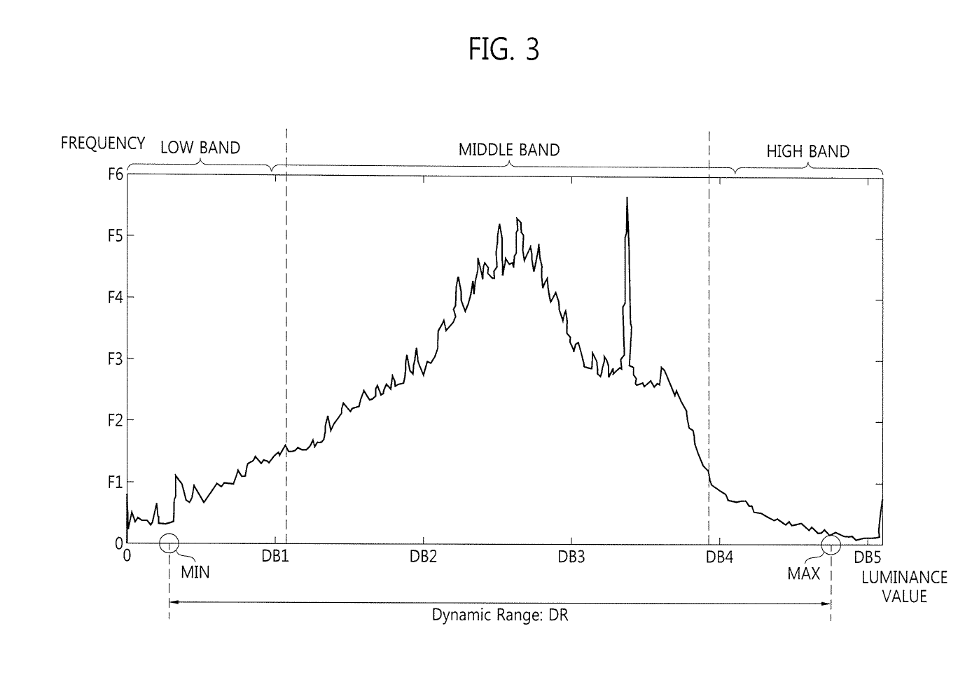

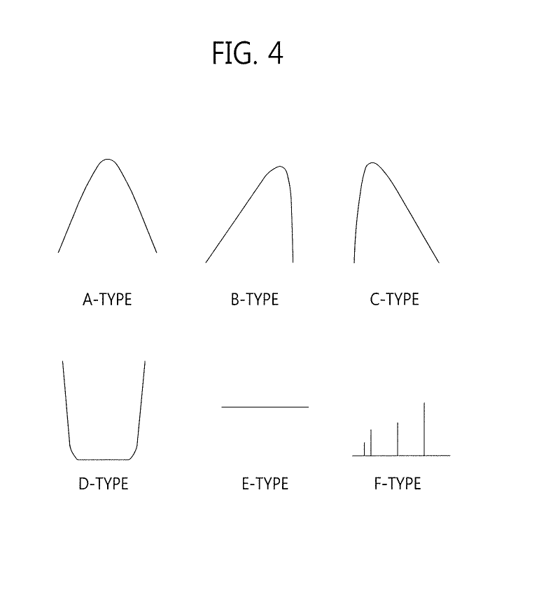

FIG. 2 is a block diagram of an image classifier 120 illustrated in FIG. 1 according to an exemplary embodiment of the present inventive concept. FIG. 3 is a diagram of a luminance histogram of an image data IDATA input to the image classifier 120 illustrated in FIG. 2 according to an exemplary embodiment of the present inventive concept. FIG. 4 is a diagram of types of image categories for explaining the operation of an image category selector 125 illustrated in FIG. 2 according to an exemplary embodiment of the present inventive concept. Referring to FIG. 2, the image classifier 120 includes a histogram generator 121, a feature extractor 123, and the image category selector 125.

The image classifier 120 classifies the current image data IDATA as one of a plurality of image categories according to the luminance distribution of the current image data IDATA and generates the image category information CA according to the classification result. For instance, the image classifier 120 may classify the current image data IDATA as one of the image categories using a luminance histogram BHG of the current image data IDATA and may generate the image category information CA according to the classification result. In addition, the image classifier 120 may transmit the current image data IDATA to the gain controller 130.

For instance, the image classifier 120 may generate a first luminance histogram for previous image data and a second luminance histogram BHG for the current image data IDATA. The image classifier 120 may extract first feature points from the first luminance histogram with respect to the previous image data and may extract second feature points from the second luminance histogram BHG with respect to the current image data IDATA. The image classifier 120 may classify the previous image data as a first image category based on the first feature points and may classify the current image data IDATA as a second image category based on the second feature points.

The histogram generator 121 may generate the luminance histogram BHG which represents the luminance distribution of the current image data IDATA. The histogram generator 121 may calculate a luminance value of each of pixels included in the current image data IDATA to generate the luminance histogram BHG.

Referring to FIG. 3, the horizontal axis is a luminance value and the vertical axis is a frequency corresponding to the luminance value. The horizontal axis may be divided into a low band, a middle band, and a high band. Each of borders between bands may be set to a value that allows the features of the luminance histogram to be classified most efficiently.

The feature extractor 123 may extract feature points from the luminance histogram BHG generated by the histogram generator 121. The feature points in the luminance histogram BHG may be parameter values PAV to determine an image category to which the current image data IDATA belongs. The parameter values PAV may be the number of pixels in the low band, the number of pixels in the middle band, the number of pixels in the high band, an average luminance value of the current image data IDATA, and/or a dynamic range DR of the luminance value in the luminance histogram BHG.

The image category selector 125 receives the parameter values PAV from the feature extractor 123, selects an image category that has the most similar feature to that of the current image data IDATA from among a plurality of image categories using the parameter values PAV, and outputs the image category information CA indicating the selected image category to the gain controller 130.

FIG. 4 shows examples of an image category that can be selected by the image category selector 125. For instance, referring to FIG. 4, images that have more pixels in the middle band than pixels in any of the high and low bands belong to an A-type image category; images that have more pixels in the high band than pixels in any of the middle and low bands belong to a B-type image category; and images that have more pixels in the low band than pixels in any of the middle and high bands belong to a C-type image category. Images that have most pixels in the high and low bands to have a high contrast belong to a D-type image category. Images that have a uniform pixel distribution throughout all bands belong to an E-type image category. Images that have a discrete distribution of luminance values belong to an F-type image category. The image categories illustrated in FIG. 4 are just examples provided for the description and the present inventive concept is not restricted thereto.

FIG. 5 is a block diagram of the gain controller illustrated in FIG. 1 according to an exemplary embodiment of the present inventive concept. Referring to FIG. 5, the gain controller 130 includes a control circuit 131, a first comparison circuit 133, and a second comparison circuit 135. The gain controller 130 may adjust a first initial gain value IBG for backlight control to be the same as a first target gain value TBG for the backlight control using the current image data IDATA and the image category information CA received from the image classifier 120. The gain controller 130 may transmit the first adjusted initial gain value BG to the backlight controller 140.

The control circuit 131 may extract the first initial gain value IBG and the first target gain value TBG using the current image data IDATA and the image category information CA. The first initial gain value IBG may correspond to image data before a scene change occurs and the first target gain value TBG may correspond to the current image data IDATA after the scene change occurs.

The first comparison circuit 133 may receive the first initial gain value IBG and the first target gain value TBG from the control circuit 131 and may linearly adjust the first initial gain value IBG using the dimming step value (e.g., DS in FIG. 6) until the first initial gain value IBG reaches the first target gain value TBG. The first comparison circuit 133 may compare an addition value obtained by adding the dimming step value DS to the first initial gain value IBG and a subtraction value obtained by subtracting the dimming step value DS from the first initial gain value IBG with the first target gain value TBG. The first comparison circuit 133 may transmit the first adjusted initial gain value BG equal to the first target gain value TBG, which is obtained through the comparison, to the backlight controller 140.

In addition, the gain controller 130 may adjust a second initial gain value ITG of a first TMF to be the same as a second target gain value TTG of a second TMF using the current image data IDATA and the image category information CA received from the image classifier 120. For example, the first TMF and the second TMF may be functions corresponding to the previous image data and the current image data IDATA, respectively. The gain controller may transmit the second adjusted initial gain value TFG to the data processing block 150. The control circuit 131 may extract the second initial gain value ITG and the second target gain value TTG using the current image data IDATA and the image category information CA. The second initial gain value ITG may correspond to image data before a scene change occurs and the second target gain value TTG may correspond to the current image data IDATA after the scene change occurs.

The second comparison circuit 135 may receive the second initial gain value ITG and the second target gain value TTG from the control circuit 131 and may linearly adjust the second initial gain value ITG using the dimming step value DS until the second initial gain value ITG reaches the second target gain value TTG. The second comparison circuit 135 may compare an addition value obtained by adding the dimming step value DS to the second initial gain value ITG and a subtraction value obtained by subtracting the dimming step value DS from the second initial gain value ITG with the second target gain value TTG. The second comparison circuit 135 may transmit the second adjusted initial gain value TFG equal to the second target gain value TTG, which is obtained through the comparison, to the data processing block 150.

FIG. 6 is a graph for explaining an operation of a gain controller 130 illustrated in FIG. 1 according to an exemplary embodiment of the present inventive concept. Referring to FIGS. 1 through 6, the previous image data and the current image data IDATA may be classified as different image categories from each other.

When the initial gain value IBG or ITG corresponding to the previous image data is less than the target gain value TBG or TTG corresponding to the current image data IDATA, the gain controller 130 may increase the initial gain value IBG or ITG using the dimming step value DS until the initial gain value IBG or ITG reaches the target gain value TBG or TTG. When the initial gain value IBG or ITG is greater than the target gain value TBG or TTG, the gain controller 130 may decrease the initial gain value IBG or ITG using the dimming step value DS until the initial gain value IBG or ITG reaches the target gain value TBG or TTG. When the target gain value TBG is between a value (e.g., IBG+DS) obtained by adding the dimming step value DS to the initial gain value IBG and a value (e.g., IBG-DS) obtained by subtracting the dimming step value DS from the initial gain value IBG, the gain controller 130 may determine the initial gain value IBG as the target gain value TBG. When the target gain value TTG is between a value (e.g., ITG+DS) obtained by adding the dimming step value DS to the initial gain value ITG and a value (e.g., ITG-DS) obtained by subtracting the dimming step value DS from the initial gain value ITG, the gain controller 130 may determine the initial gain value ITG as the target gain value TTG.

It is assumed that a scene change occurs at time points ST1, ST2, and ST3 in FIG. 6. At this time, it is assumed that image data before the time point ST1 is classified as a first image category, image data after the time point ST1 is classified as a second image category, image data after the time point ST2 is classified as a third image category, and image data after the time point ST3 is classified as a fourth image category.

Referring to FIGS. 1 through 6, the gain controller 130 may linearly adjust the initial gain value IG corresponding to the first image category using the dimming step value DS until the initial gain value IG reaches a target gain value TG1 corresponding to the second image category. At this time, since the initial gain value IG is less than the target gain value TG1, the gain controller 130 may increase the initial gain value IG step by step by adding the dimming step value DS to the initial gain value IG until the initial gain value IG is the same as the target gain value TG1.

In addition, the gain controller 130 may linearly adjust an initial gain value TG1 corresponding to the second image category using the dimming step value DS until the initial gain value TG1 reaches a target gain value TG2 corresponding to the third image category. For example, the initial gain value TG1 could have previously been the target value TG1. At this time, since the initial gain value TG1 is greater than the target gain value TG2, the gain controller 130 may decrease the initial gain value TG1 step by step by subtracting the dimming step value DS from the initial gain value TG1 until the initial gain value TG1 is the same as the target gain value TG2.

In addition, the gain controller 130 may linearly adjust an initial gain value TG2 corresponding to the third image category using the dimming step value DS until the initial gain value TG2 reaches a target gain value TG3 corresponding to the fourth image category. For example, the initial gain value TG2 could have previously been the target value TG2. At this time, since the initial gain value TG2 is less than the target gain value TG3, the gain controller 130 may increase the initial gain value TG2 step by step by adding the dimming step value DS to the initial gain value TG2 until the initial gain value TG2 is the same as the target gain value TG3.

The gain values IG, TG1, TG2, and TG3 may be the gain values ITG, TTG, and TFG of a TMF or the gain values IBG, TBG, and BG for backlight control. The dimming step value DS may have been set in advance in the gain controller 130 according to a type of the current image data IDATA. The dimming step value DS may be programmable.

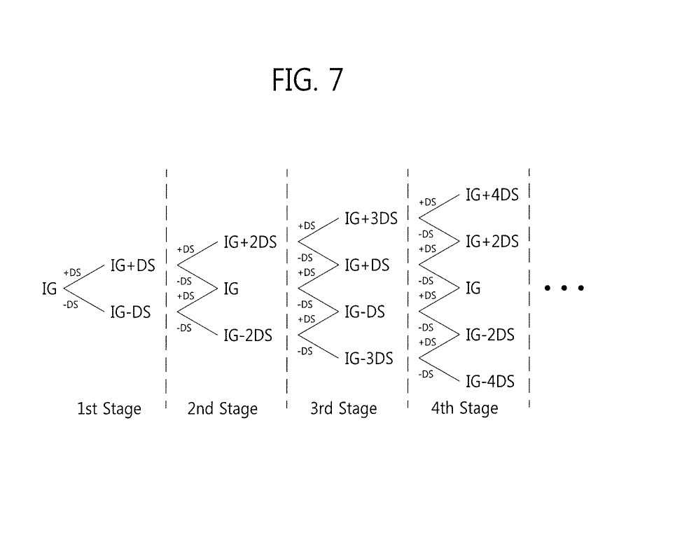

FIG. 7 is a diagram for explaining the operation of the gain controller 130 illustrated in FIG. 1 according to an exemplary embodiment of the present inventive concept. FIG. 7 is provided to describe in detail the operation of the gain controller 130 illustrated in FIG. 6. FIG. 7 shows a method of adjusting the initial gain value IG step by step until the initial gain value IG reaches the target gain value TG.

Referring to FIG. 7, the gain controller 130 may generate a first addition value IG+DS by adding the dimming step value DS to the initial gain value IG and a first subtraction value IG−DS by subtracting the dimming step value DS from the initial gain value IG. The gain controller 130 may compare the first addition value IG+DS and the first subtraction value IG−DS with the target gain value TG in a first stage. When the target gain value TG ranges between the first addition value IG+DS and the first subtraction value IG−DS according to the comparison result, the gain controller 130 may set the initial gain value IG to the target gain value TG. When the target gain value TG is the same as the first addition value IG+DS or the first subtraction value IG−DS according to the comparison result, the gain controller 130 may set the initial gain value IG to the first addition value IG+DS or the first subtraction value IG−DS.

When the target gain value TG is greater than the first addition value IG+DS in the first stage, the gain controller 130 may generate a second addition value IG+2DS by adding the dimming step value DS to the first addition value IG+DS and compare the second addition value IG+2DS with the target gain value TG in a second stage. When the target gain value TG ranges between the first addition value IG+DS and the second addition value IG+2DS according to the comparison result, the gain controller 130 may set the initial gain value IG to the target gain value TG. When the target gain value TG is the same as the second addition value IG+2DS, the gain controller 130 may set the initial gain value IG to the second addition value IG+2DS.

When the target gain value TG is less than the first subtraction value IG−DS in the first stage, the gain controller 130 may generate a second subtraction value IG−2DS by subtracting the dimming step value DS from the first subtraction value IG−DS and compare the second subtraction value IG−2DS with the target gain value TG in the second stage.

When the target gain value TG ranges between the first subtraction value IG−DS and the second subtraction value IG−2DS according to the comparison result, the gain controller 130 may set the initial gain value IG to the target gain value TG. When the target gain value TG is the same as the second subtraction value IG−2DS according to the comparison result, the gain controller 130 may set the initial gain value IG to the second subtraction value IG−2DS.

A method of adjusting the initial gain value IG until the initial gain value IG is the same as the target gain value TG in third, fourth, and further stages is substantially the same as that performed in the second stage.

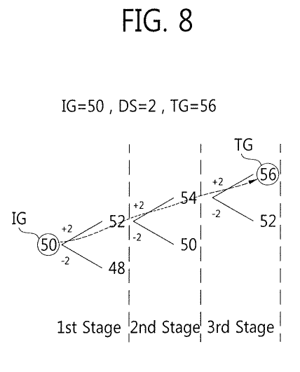

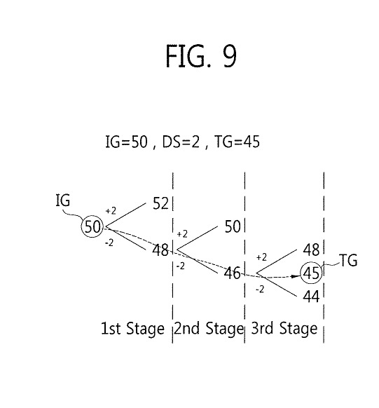

FIG. 8 is a diagram for explaining the operation of the gain controller 130 illustrated in FIG. 1 according to an exemplary embodiment of the present inventive concept. FIG. 9 is a diagram for explaining an example of the operation of the gain controller 130 illustrated in FIG. 1.

Referring to FIGS. 6 through 8, it is assumed that the initial gain value IG is 50, the dimming step value DS is 2, and the target gain value TG is 56. In the first stage, the gain controller 130 generates a first addition value of 52 by adding the dimming step value DS of 2 to the initial gain value IG of 50 and a first subtraction value of 48 by subtracting the dimming step value DS of 2 from the initial gain value IG of 50. The gain controller 130 compares the first addition value of 52 and the first subtraction value of 48 with the target gain value TG of 56.

Since the target gain value TG of 56 is greater than the first addition value of 52 according to the comparison result, the gain controller 130 generates a second addition value of 54 by adding the dimming step value DS of 2 to the first addition value of 52 and compares the second addition value of 54 with the target gain value TG of 56 in the second stage.

Since the target gain value TG of 56 is greater than the second addition value of 54 according to the comparison result, the gain controller 130 generates a third addition value of 56 by adding the dimming step value DS of 2 to the second addition value of 54 and compares the third addition value of 56 with the target gain value TG of 56 in the third stage. Since the target gain value TG of 56 is the same as the third addition value of 56 according to the comparison result, the gain controller 130 may adjust the initial gain value IG to the third addition value of 56 so that the initial gain value IG is the same as the target gain value TG of 56.

Referring to FIGS. 6, 7, and 9, it is assumed that the initial gain value IG is 50, the dimming step value DS is 2, and the target gain value TG is 45. In the first stage, the gain controller 130 generates a first addition value of 52 by adding the dimming step value DS of 2 to the initial gain value IG of 50 and a first subtraction value of 48 by subtracting the dimming step value DS of 2 from the initial gain value IG of 50. The gain controller 130 compares the first addition value of 52 and the first subtraction value of 48 with the target gain value TG of 45.

Since the target gain value TG of 45 is less than the first subtraction value of 48 according to the comparison result, the gain controller 130 generates a second subtraction value of 46 by subtracting the dimming step value DS of 2 from the first subtraction value of 48 and compares the second subtraction value of 46 with the target gain value TG of 45 in the second stage.

Since the target gain value TG of 45 is less than the second subtraction value of 46 according to the comparison result, the gain controller 130 generates a third subtraction value of 44 by subtracting the dimming step value DS of 2 from the second subtraction value of 46 and compares the third subtraction value of 44 with the target gain value TG of 45 in the third stage. Since the target gain value TG of 45 is greater than the third subtraction value of 44 and less than the second subtraction value of 46 according to the comparison result, the gain controller 130 may adjust the initial gain value IG to 45 so that the initial gain value IG is the same as the target gain value TG of 45.

FIG. 10 is a block diagram of the data processing block 150 illustrated in FIG. 1 according to an exemplary embodiment of the present inventive concept. Referring to FIGS. 1 and 10, the data processing block 150 includes a bit extender 151, a TMF control block 153, and a dithering block 155.

The bit extender 151 may receive the current image data IDATA, which includes pixels having a first number of bits (for example, 8 bits), extend the pixels to have a second number of bits (for example, 10 bits), and transmit extended image data EDATA including the pixels having the second number of bits to the TMF control block 153.

The TMF control block 153 may generate the final TMF (e.g., FTMF in FIG. 12) using the extended image data EDATA output from the bit extender 151, the second initial gain value TFG output from the gain controller 130, and the reference function (e.g., RC in FIG. 11). The TMF control block 153 may transmit final image data FDATA generated using the extended image data EDATA and the final TMF FTMF to the dithering block 155. The pixels included in the extended image data EDATA have the same number of bits (for example, of 10 bits) as pixels included in the final image data FDATA.

The dithering block 155 may receive the final image data FDATA from the TMF control block 153, convert the second number of bits of the pixels included in the final image data FDATA into the first number of bits, and output the dithered output image data DDATA including pixels having the first number of bits to the display driver circuit 160.

FIG. 11 is a diagram for explaining an operation of the data processing block 150 illustrated in FIG. 1 according to an exemplary embodiment of the present inventive concept. The horizontal axis of a graph illustrated in FIG. 11 is normalized input data to the data processing block 150 and the vertical axis is normalized output data from the data processing block 150. Referring to FIG. 11, the TMF MTMF may be a first-order function having a first slope. The first slope may be the reciprocal (e.g., 1/TFG) of the second initial gain value TFG. The TMF MTMF may be calculated using Equation 1:

$$MTMF = YOUT = ( \frac{1}{TFG} ) \times YIN , \qquad ( 1 )$$

where YIN is the current image data IDATA and YOUT is output data.

Referring to FIG. 11, the reference function RC may be applied in common to input data for effective image reproduction and may be set by the data processing block 150 according to a type of the current image data IDATA. The reference function RC may be calculated using Equation 2:

RC=YOUT=A×YIN+B×YIN²+C×YIN³+D×YIN⁴, (2)

where YIN is the current image data IDATA, YOUT is output data, and A, B, C, and D are coefficients.

The order of the reference function RC is higher than that of the TMF MTMF. In an exemplary embodiment of the present inventive concept, the reference function RC may be generated using a lookup table that stores values for minimizing deterioration of the picture quality of the current image data IDATA.

The final TMF FTMF may be generated using the TMF MTMF and the reference function RC. For example, the final TMF FTMF may be the same as the TMF MTMF in a range from an initial value (e.g., “0”) of the normalized current image data IDATA to a first value of the normalized current image data IDATA and may be the same as the reference function RC in a range from the first value to a last value (e.g., “1”) of the normalized current image data IDATA. The first value CPV may correspond to a value of the intersection CPn between the TMF MTMF and the reference function RC. In an exemplary embodiment of the present inventive concept, the normalized current image data IDATA may be replaced with the extended image data EDATA.

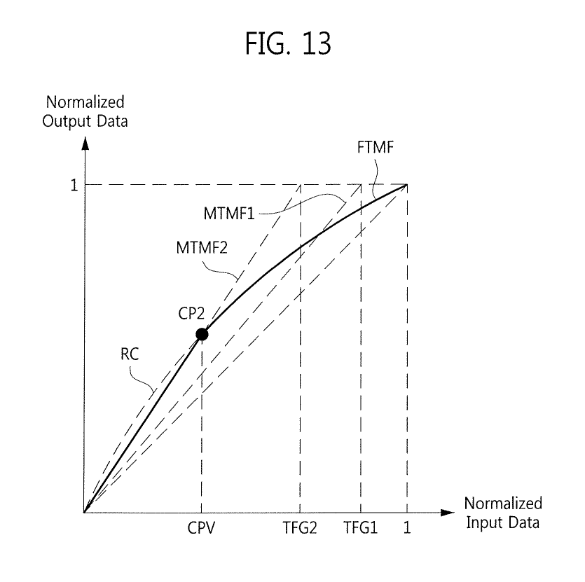

FIG. 12 is a graph for explaining a method of generating a final TMF FTMF using the data processing block 150 illustrated in FIG. 1 according to an exemplary embodiment of the present inventive concept. FIG. 13 is a graph for explaining a method of generating a final TMF FTMF using the data processing block 150 illustrated in FIG. 1 according to an exemplary embodiment of the present inventive concept. Referring to FIGS. 10 through 13, the horizontal axes of the graphs illustrated in FIGS. 12 and 13 are normalized input data and the vertical axes thereof are normalized output data.

The reference function RC may be a function set according to a type of the current image data IDATA. First TMF MTMF1 may be determined by a first value TFG1, and second TMF MTMF2 may be determined by a second value TFG2. The first and second values TFG1 and TFG2 may be obtained by normalizing the second initial gain value TFG that has been adjusted to the same as the target gain value TG1 or TG2 of a TMF. Referring to FIG. 12, the reference function RC and the first TMF MTMF1 may have an intersection CP1 therebetween. Referring to FIG. 13, the reference function RC and the second TMF MTMF2 may have an intersection CP2 therebetween. The final TMF FTMF may be generated in the same form as the reference function RC or the first TMF MTMF1 or the second TMF MTMF2 based on the value CPV of the normalized current image data IDATA corresponding to the intersection CP1 or CP2.

Referring to FIG. 12, the first TMF MTMF1 is determined by the value TFG1 obtained by normalizing adjusted the second initial gain value TFG. The first TMF MTMF1 and the reference function (or a reference curve) RC have the value CPV of the normalized current image data IDATA corresponding to the intersection CP1. The final TMF FTMF is the same as the first TMF MTMF1 in a range from the initial value (e.g., “0”) of the normalized current image data IDATA to the value CPV of the normalized current image data IDATA corresponding to the intersection CP1 and is the same as the reference curve RC in a range from the value CPV of the normalized current image data IDATA corresponding to the intersection CP1 to the last value (e.g., “1”) of the normalized current image data IDATA.

Referring to FIG. 13, the second TMF MTMF2 is determined by the value TFG2 obtained by normalizing adjusted the second initial gain value TFG. The TMF MTMF2 and the reference function RC have the value CPV of the normalized current image data IDATA corresponding to the intersection CP2. The final TMF FTMF is the same as the TMF MTMF2 in a range from the initial value (e.g., “0”) of the normalized current image data IDATA to the value CPV of the normalized current image data IDATA corresponding to the intersection CP2 and is the same as the reference curve RC in a range from the value CPV of the normalized current image data IDATA corresponding to the intersection CP2 to the last value (e.g., “1”) of the normalized current image data IDATA.

When the final TMF FTMF illustrated in FIG. 12 corresponds to previous image data, the final TMF FTMF illustrated in FIG. 13 may correspond to current image data.

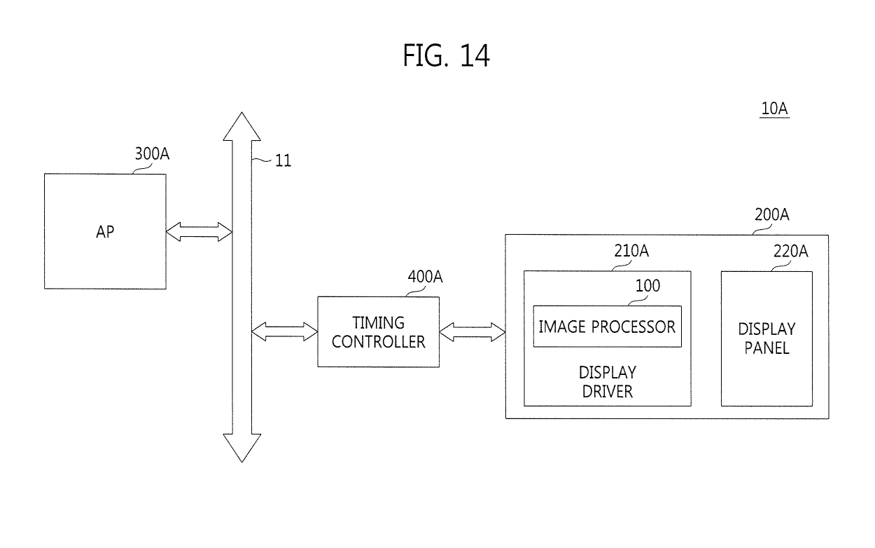

FIG. 14 is a block diagram of an image processing system 10A according to an exemplary embodiment of the present inventive concept. Referring to FIG. 14, the image processing system 10A includes a bus 11, a display 200A, an application processor (AP) 300A, and a timing controller 400A.

The display 200A includes a display driver 210A and a display panel 220A. The image processor 100 described with reference to FIGS. 1 through 13 may be formed within the display driver 210A. The display driver 210A may be implemented in a chip.

The display driver 210A may control the display panel 220A. The display panel 220A may display an image corresponding to the dithered output image data DDATA. The AP 300A may be implemented as an integrated circuit (IC), a system on chip (SoC), a mobile AP, or the like. The AP 300A may control the operation of the timing controller 400A and may communicate with the timing controller 400A through the bus 11.

The timing controller 400A may transmit the current image data IDATA to the display 200A. The timing controller 400A may be implemented in a chip.

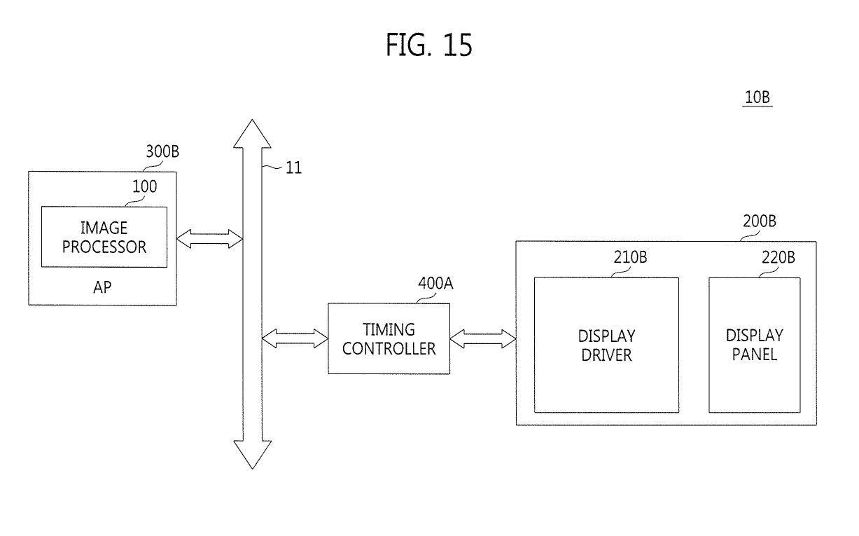

FIG. 15 is a block diagram of an image processing system 10B according to an exemplary embodiment of the present inventive concept. Referring to FIG. 15, the image processing system 10B includes the bus 11, a display 200B, an AP 300B, and the timing controller 400A. The display 200B includes a display driver 210B and a display panel 220B. The display driver 210B may control the display panel 220B. The display panel 220B may display an image corresponding to the dithered output image data DDATA.

The image processor 100 described with reference to FIGS. 1 through 13 may be formed within the AP 300B. The AP 300B may be implemented as an IC, an SoC, a mobile AP, or the like. The AP 300B may control the operation of the timing controller 400A and may communicate with the timing controller 400A through the bus 11. The timing controller 400A may transmit the current image data IDATA to the display 200B.

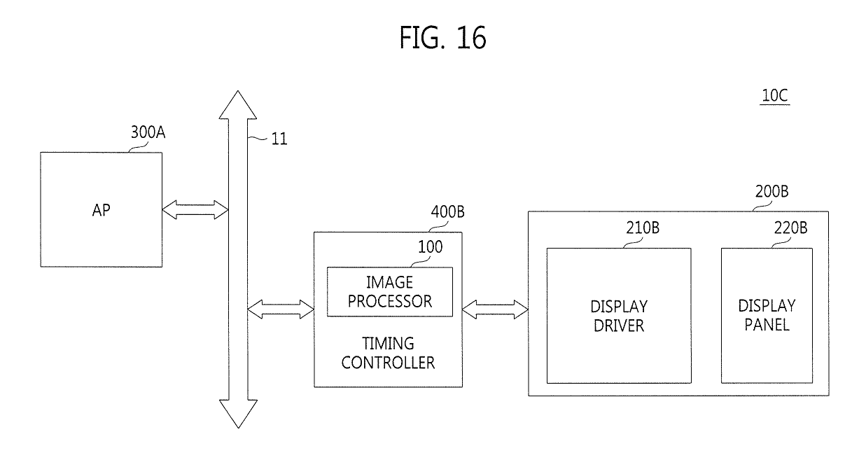

FIG. 16 is a block diagram of an image processing system 10C according to an exemplary embodiment of the present inventive concept. Referring to FIG. 16, the image processing system 10C includes the bus 11, the display 200B, the AP 300A, and a timing controller 400B. The display 200B illustrated in FIG. 16 is substantially the same as the display 200B illustrated in FIG. 15 and the AP 300A illustrated in FIG. 16 is substantially the same as the AP 300A illustrated in FIG. 14.

The timing controller 400B receives the current image data IDATA. The dithered output image data DDATA generated by the image processor 100 may be transmitted to the display 200B. The timing controller 400B may be implemented in a chip.

As described above, according to an exemplary embodiment of the present inventive concept, an image processor may minimize deterioration of picture quality and reduce power consumption during tone mapping control and backlight unit control.

While the present inventive concept has been particularly shown and described with reference to exemplary embodiments thereof, it will be understood by those of ordinary skill in the art that various changes in forms and details may be made therein without departing from the spirit and scope of the present inventive concept as defined in the following claims.

1. An image processor comprising:
a gain controller configured to adjust an initial gain value of a first tone mapping function corresponding to first image data using a dimming step value until the initial gain value is the same as a target gain value of a second tone mapping function corresponding to second image data; and
a data processing block configured to generate a final tone mapping function using a reference function and a third tone mapping function generated based on the adjusted initial gain value,
wherein the first image data is data before a scene change occurs, and the second image data is data after the scene change occurs,
wherein the third tone mapping function is a first-order function generated using the adjusted initial gain value, and
wherein an order of the reference function is higher than an order of the third tone mapping function.

2. The image processor of claim 1, further comprising an image classifier configured to classify the first image data as a first image category, and to classify the second image data as a second image category.

3. The image processor of claim 1, wherein the gain controller increases the initial gain value using the dimming step value until the initial gain value reaches the target gain value when the initial gain value is less than the target gain value.

4. The image processor of claim 1, wherein the gain controller decreases the initial gain value using the dimming step value until the initial gain value reaches the target gain value when the initial gain value is greater than the target gain value.

5. The image processor of claim 1, wherein the gain controller sets the initial gain value to the target gain value when the target gain value is between a first value and a second value, wherein the first value is obtained by adding the dimming step value to the initial gain value and the second value is obtained by subtracting the dimming step value from the initial gain value.

6. The image processor of claim 1, wherein the final tone mapping function is the same as the third tone mapping function in a range from an initial value of the second image data to a first value of the second image data, and the final tone mapping function is the same as the reference function in a range from the first value to a last value of the second image data,
wherein the first value corresponds to an intersection of the third tone mapping function and the reference function.

7. The image processor of claim 1, wherein the data processing block comprises:
a bit extender configured to convert the second image data having a first number of bits into extended image data having a second number of bits greater than the first number of bits;
a tone mapping function control block configured to generate the final tone mapping function using the extended image data, the adjusted initial gain value, and the reference function, and to generate final image data using the extended image data and the final tone mapping function; and
a dithering block configured to convert the final image data into output image data having the first number of bits, and to output the output image data.

8. The image processor of claim 1, wherein the dimming step value is programmable.

9. The image processor of claim 1, wherein the reference function is generated using a look-up table that stores values for minimizing deterioration of picture quality of the second image data.

10. The image processor of claim 2, wherein the image classifier comprises:
a histogram generator configured to generate a first luminance histogram of the first image data and a second luminance histogram of the second image data;
a feature extractor configured to extract first feature points of the first image data from the first luminance histogram, and to extract second feature points of the second image data from the second luminance histogram; and
an image category selector configured to classify the first image data as the first image category using the first feature points, and to classify the second image data as the second image category using the second feature points.

11. An image processing system comprising:
a display; and
an image processor configured to output image data to the display,
wherein the image processor comprises:
a gain controller configured to adjust an initial gain value of a first tone mapping function corresponding to first image data using a dimming step value until the initial gain value is the same as a target gain value of a second tone mapping function corresponding to second image data; and
a data processing block configured to generate a final tone mapping function using a reference function and a third tone mapping function generated based on the adjusted initial gain value and to output the output image data generated using the final tone mapping function,
wherein the first image data is data before a scene change occurs, and the second image data is data after the scene change occurs,
wherein the tone mapping function is a first-order function generated using the adjusted initial gain value, and
wherein an order of the reference function is higher than an order of the third tone mapping function.

12. The image processing system of claim 11, wherein the gain controller increases the initial gain value using the dimming step value until the initial gain value reaches the target gain value when the initial gain value is less than the target gain value,
wherein the gain controller decreases the initial gain value using the dimming step value until the initial gain value reaches the target gain value when the initial gain value is greater than the target gain value.

13. The image processing system of claim 11, wherein the final tone mapping function is the same as the third tone mapping function in a range from an initial value of the second image data to a first value of the second image data, and the final tone mapping function is the same as the reference function in a range from the first value to a last value of the second image data,
wherein the first value corresponds to an intersection of the third tone mapping function and the reference function.

14. The image processing system of claim 11, wherein the data processing block comprises:
a bit extender configured to convert the second image data having a first number of bits into extended image data having a second number of bits greater than the first number of bits;
a tone mapping function control block configured to generate the final tone mapping function using the extended image data, the adjusted initial gain value, and the reference function, and to generate final image data using the extended image data and the final tone mapping function; and
a dithering block configured to convert the final image data into output image data having the first number of bits, and to output the output image data.

15. An image processor comprising:
a gain controller configured to adjust an initial gain value for a backlight control corresponding to first image data using a dimming step value until the initial gain value is the same as a target gain value for a backlight control corresponding to second image data; and
a backlight controller configured to output a backlight control signal using the adjusted initial gain value,
wherein the first image data is data before a scene change occurs, and the second image data is data after the scene change occurs.

16. The image processor of claim 15, further comprising an image classifier configured to classify the first image data as a first image category, and to classify the second image data as a second image category,
wherein the initial gain value corresponds to the first image category and the target gain value corresponds to the second image category.

17. The image processor of claim 15, wherein the gain controller increases the initial gain value using the dimming step value until the initial gain value reaches the target gain value when the initial gain value is less than the target gain value.

18. The image processor of claim 15, wherein the gain controller decreases the initial gain value using the dimming step value until the initial gain value reaches the target gain value when the initial gain value is greater than the target gain value.

19. The image processor of claim 15, wherein the gain controller adjusts the initial gain value to the target gain value when the target gain value is between a first value obtained by adding the dimming step value to the initial gain value and a second value obtained by subtracting the dimming step value from the initial gain value.

20. The image processor of claim 15, wherein the dimming step value is programmable.

21. (canceled)
